(19) United States
(12) Patent Application Publication
(10) Pub. No.: US 2010/0057570 A1
(43) Pub. Date: Mar. 4, 2010

(54) Method and system for providing advertising and entertainment data

(75) Inventors: Jonathan Barsook, Los Angeles, CA (US); Ariff Sidi, Studio City, CA (US); Jason R. Grant, Valencia, CA (US); Skarpi Hedinsson, Stevenson Ranch, CA (US); Shannon Monroe, Burbank, CA (US)

Correspondence Address: DISNEY ENTERPRISES;C/O FARJAMI & FARJAMI LLP, 26522 LA ALAMEDA AVENUE, SUITE 360, MISSION VIEJO, CA, 92691, US

(73) Assignee: DISNEY ENTERPRISES, INC., Burbank, CA (US)

(21) Appl. No.: 12/231,234

(22) Filed: Aug. 29, 2008

(51) Int. Cl. G06Q 30/00; H04N 7/025

(52) U.S. Cl. 705/14.55; 725/34

(57) ABSTRACT

There is provided a method of providing a plurality of advertisement data and a plurality of entertainment data. The method comprises receiving a first request from a user device for entertainment data. The method also comprises transmitting advertisement data to the user device in response to the first request, wherein the advertisement data include a first advertising expiration data associated with the advertisement data for use to disable a display of advertisement data by the user device after an expiration of the first advertising expiration data. The method additionally comprises transmitting the entertainment data to the user device in response to the first request, wherein the entertainment data include a first entertainment expiration data for use to disable a display of the entertainment data by the user device after an expiration of either the first entertainment expiration data or the first advertising expiration data.

### BACKGROUND OF THE INVENTION

1. Field of the Invention

The present invention is generally in the field of communication technology. More particularly, the present invention relates to advertisement and entertainment communication systems and methods.

2. Background Art

Methods and systems for providing advertising and entertainment data have developed apace with the advance of communication technologies. For example, as print, radio, television, and online content-delivery methods and systems have matured, advertising-delivery methods and systems have matured in parallel. Thus, in the modern practice, advertising and entertainment data are delivered to consumers in a variety of ways. Notably, online content- and advertising-delivery methods and systems, being younger than their print, radio, and television cousins, have not advanced quite as far. This is not an indication that methods and systems for providing advertising and entertainment data online are not effective. As an example, advertising can be delivered with written articles on a web page, and text ads can be targeted to particular consumers in Internet search results. Furthermore, as another example, advertising can be embedded in audio or audiovisual media delivered via the Internet.

However, methods and systems for providing advertising and entertainment data that operate online still suffer from drawbacks. For instance, mobile computers and other mobile devices might be used in areas with Internet connectivity, such as in the home or at a wireless hotspot, and also used in areas with no Internet connectivity, such as in a remote area or on an airplane. Providing advertising and entertainment data to such devices can be difficult, because coordinating the delivery of advertising and entertainment data with the devices when they are online poses a challenge.

Other unique requirements often imposed in the advertising arts also pose challenges. For example, an advertisement might be provided subject to the requirement that the advertisement not be shown to a consumer past a certain date. The consequence of showing a particular advertisement to a consumer past a certain date includes, for example, consumer frustration or confusion because advertised sales or other events have passed. Another unique requirement imposed in the advertising arts is, for example, that an advertisement not be shown more than a predetermined number of times, i.e. the advertisement has an agreed impression limit. The consequence of showing a particular advertisement more than the predetermined number of times includes, for example, an unearned benefit accruing to the advertiser. Meeting such unique requirements is a particular challenge when providing advertising and entertainment data to devices that can be utilized both online and offline.

Accordingly, there is a need to overcome the drawbacks and deficiencies in the art by offering an improved method and system for providing advertising and entertainment data to consumers.

### SUMMARY OF THE INVENTION

There are provided methods and systems for providing advertising and entertainment data, substantially as shown in and/or described in connection with at least one of the figures, and as set forth more completely in the claims.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1 shows a diagram of an exemplary system for providing advertising and entertainment data, according to one embodiment of the present invention;

FIG. 2 shows a diagram of an exemplary user device for providing advertising and entertainment data, according to one embodiment of the present invention;

FIG. 3 shows a diagram of an exemplary user device for providing advertising and entertainment data, according to one embodiment of the present invention; and

FIG. 4 shows a flowchart presenting an exemplary method for providing advertising and entertainment data, according to one embodiment of the present invention.

### DETAILED DESCRIPTION OF THE INVENTION

The present invention is directed to a method and system for providing advertising and entertainment data. Although the invention is described with respect to specific embodiments, the principles of the invention, as defined by the claims appended herein, can obviously be applied beyond the specific embodiments of the invention described herein. Moreover, in the description of the present invention, certain details have been left out in order to not obscure the inventive aspects of the invention. The details left out are within the knowledge of a person of ordinary skill in the art. The drawings in the present application and their accompanying detailed description are directed to merely exemplary embodiments of the invention. To maintain brevity, other embodiments of the invention, which use the principles of the present invention are not specifically described in the present application and are not specifically illustrated by the present drawings.

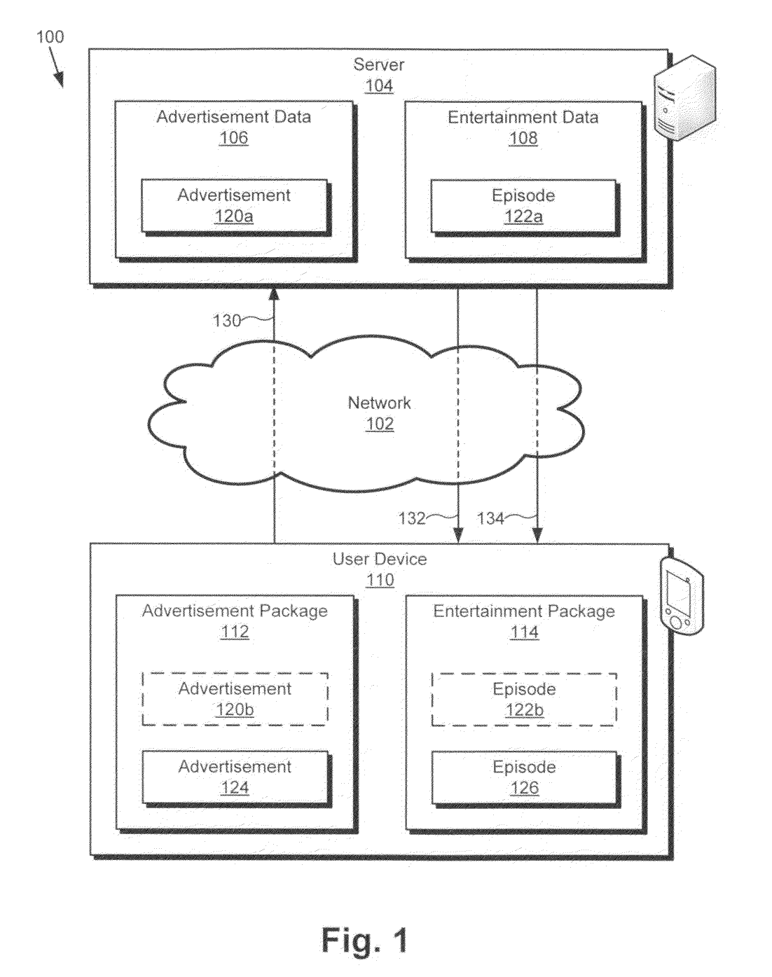

FIG. 1 shows exemplary system 100 according to one embodiment of the present invention. System 100 comprises server 104, which is configured in one embodiment to provide advertisement data, such as advertisement 120a, and entertainment data, such as episode 122a, to a user device, such as user device 110. Server 104 may be implemented as, for example, a computer comprising a processor and a memory, as known in the art, and may be located in, for example, a data center with additional servers. System 100 also comprises user device 110 which can be implemented as, for example, a computer comprising a processor and a memory, as known in the art, such as a laptop or desktop computer. User device 110 may also be implemented as, for example, a cell phone or a personal digital assistant (e.g. an iPhone). User device 110 and server 104 are configured to be coupled for communication by network 102 which may comprise, for example, the Internet. User device 110 is configured for communication with server 104 in several transactions (e.g. transactions 130, 132, and 134) as discussed further below.

Server 104 comprises advertisement data 106 and entertainment data 108. In one embodiment, advertisement data 106 and entertainment data 108 are implemented as regions of memory in the memory of server 104. In another embodiment, advertisement data 106 and entertainment data 108 could be implemented as, for example, storage on a hard drive, or storage in one or more databases, as known in the art. Advertisement data 106 is configured to store a plurality of advertisement data, such as advertisement 120a, and entertainment data 108 is configured to store a plurality of entertainment data, such as episode 122a.

User device 110 comprises advertisement package 112 and entertainment package 114. In one embodiment, advertisement package 112 and entertainment package 114 are, in a manner similar to advertisement data 106 and entertainment data 108 of server 104, implemented as regions of memory in the memory of user device 110. In another embodiment, advertisement package 112 and entertainment package 114 could be implemented as, for example, storage on a laptop computer hard drive or personal digital assistant hard drive, as known in the art. Advertisement package 112 is configured to store, for example, a plurality of advertisement data, such as advertisement 120b and advertisement 124, and entertainment package 114 is configured to store, for example, a plurality of entertainment data, such as episode 122b and episode 126.

In one embodiment of the present invention, advertisements and episodes (e.g. advertisement 120a and episode 122a) are, for example, audiovisual media, such as media that can be played on a television screen and on audio speakers. In another embodiment, advertisements and episodes may be, for example, audio-only media such as an audio advertisement and an audio commentary (e.g., a podcast), respectively. Together, advertisements and episodes are utilized, in one embodiment, by user device 110 for playing ad-supported content. Thus, for example, user device 110 may be provided an episode (e.g. episode 122b) for display at no cost, and may also be provided an advertisement (e.g. advertisement 120b) for display before, during, or after episode 122b. For example, advertisement 120b can be implemented as an advertisement for a special-offer event at a Disney theme park, and episode 122b may be a full episode of the television show “Lost.” Thus, for example, while watching a display of the episode of Lost on user device 110, during a commercial break a user of user device 110 is shown the advertisement for the special-offer event.

In addition to comprising, for example, audiovisual media, advertisements and episodes (e.g. advertisement 120a and episode 122a) also comprise an associated first advertising expiration data and an associated first entertainment expiration data, respectively. The first advertising expiration data associated with advertisement 120a, for example, is implemented as, in one embodiment, a date and time stamp, such that after the date and time represented by the stamp advertisement 120a expires. Thus, for example, an advertisement for a special-offer event at the Disney theme park may also comprise a date and time stamp so that the advertisement expires after the special-offer event has occurred. Similarly, the first entertainment expiration data may also be implemented as a date and time stamp, such that after the date and time represented by the stamp episode 122a expires. Thus, in one embodiment an episode of Lost may comprise a first entertainment expiration data configured such that the episode expires after a use-period (e.g., six months) has expired.

In one embodiment, the first advertising expiration data and the first entertainment expiration data of the advertisements and episodes (e.g. advertisement 120a and episode 122a) are not implemented as date and time stamps. Instead, the first advertising expiration data and the first entertainment data are implemented as, for example, impression limits, such that an advertisement or an episode expires after a predetermined number, or count, of displays. Such an impression limit implementation is valuable if, for example, an advertiser purchases advertisement 120a to be displayed a limited number (e.g. 10) times. In such an embodiment, server 104 can be configured, for example, to receive from user device 110 an advertising report detailing, for example, how many times an advertisement has been displayed.

In one embodiment, the first advertising expiration data associated with an advertisement (e.g. advertisement 124) affects the display of an episode as well as the display of the associated advertisement. For example, if the first advertising expiration data is implemented as a date and time stamp, a user device such as user device 110 is configured in one embodiment to disable a display of episodes in entertainment package 114 if advertisement package 112 does not contain an unexpired advertisement. In this way, one embodiment of the invention prevents the display of an episode on user device 110 if user device 110 does not have an advertisement to display also.

As shown in FIG. 1, advertisement 120a and episode 122a are stored in advertisement data 106 and entertainment data 108 of server 104, while advertisement 124 and episode 126 are stored in advertisement package 112 and entertainment package 114 of user device 110. During transactions 130, 132, and 134, for example, copies of advertisement 120a and episode 122a (e.g. advertisement 120b and episode 122b) are transmitted from server 104 to user device 110.

During transaction 130, in one embodiment of the present invention user device 110 transmits a first request to server 104. The first request can be implemented, for example, as a digital message transmitted via network 102. The first request can be configured, for example, as a request for one or more of the plurality of entertainment data stored in entertainment data 108. The first request can also be configured, for example, as a request for one or more of the plurality of advertisement data stored in advertisement data 106. In one embodiment, the first request can be configured as a request for both, i.e. one or more of the plurality of entertainment data and one or more of the plurality of advertisement data.

User device 110 may transmit the first request during transaction 130 under a variety of different circumstances. For example, in one circumstance, user device 110 transmits the first request after the first advertising expiration data of advertisement 124 has expired. In such a circumstance, in which the first advertising expiration data is implemented as a date and time stamp, and in which advertisement 124 is the only advertisement stored in user device 110, user device 110 is configured such that no episode (e.g. episode 126) can be displayed until an advertisement having an unexpired first advertising expiration data is stored. As such, the first request is configured as a request for one or more of the plurality of advertisement data stored in advertisement data 106. Server 104 responds, in transaction 132, by transmitting to user device 110 advertisement 120b associated with a first advertising expiration data that is not yet expired. User device 110 may thereby display episode 126 again.

In another circumstance, user device 110 may transmit the first request during transaction 130 after the first entertainment expiration data of episode 126 has expired. In such an circumstance, in which the first entertainment expiration data is implemented as a date and time stamp, user device 110 is configured such that episode 126 cannot be displayed. As such, the first request is configured as a request for one or more of the plurality of entertainment data stored in entertainment data 108. Server 104 responds, in transaction 134, by transmitting to user device 110 episode 122b having a first entertainment expiration data that is not yet expired. User device 110 may thereby display episode 122b (but not episode 126, which still has an expired first entertainment expiration data).

In a variation of the circumstance described above, user device 110 transmits the first request during transaction 130 after the first entertainment expiration data of episode 126 expires, and the first request is configured as a request for both one or more of the plurality of entertainment data and one or more of the plurality of advertisement data. Such a variation may occur when the first entertainment expiration data of episode 126 has expired, and the first advertising expiration data of advertisement 124 is near expiration, but not yet expired. Server 104 responds, in transactions 132 and 134, by transmitting to user device. 110 advertisement 120b and episode 122b having a first advertising expiration data and a first entertainment expiration data that are not yet expired. User device 110 may thereby display episode 122b without being effected by the expiration of the first advertising expiration data of advertisement 124. Instead, the display of episode 122b will instead be limited by, for example, the later expiration of the first advertising expiration data of advertisement 120b.

In one embodiment, subsequent to transactions 130, 132, and 134, user device 110 transmits a second request to server 104. Like the first request, the second request can be configured, for example, as a request for one or more of the plurality of entertainment data stored in entertainment data 108. The second request can also be configured, for example, as a request for one or more of the plurality of advertisement data stored in advertisement data 106. In one embodiment, the second request can be configured as a request for both, i.e. one or more of the plurality of entertainment data and one or more of the plurality of advertisement data, each associated with a second entertainment expiration data and second advertising expiration data, respectively.

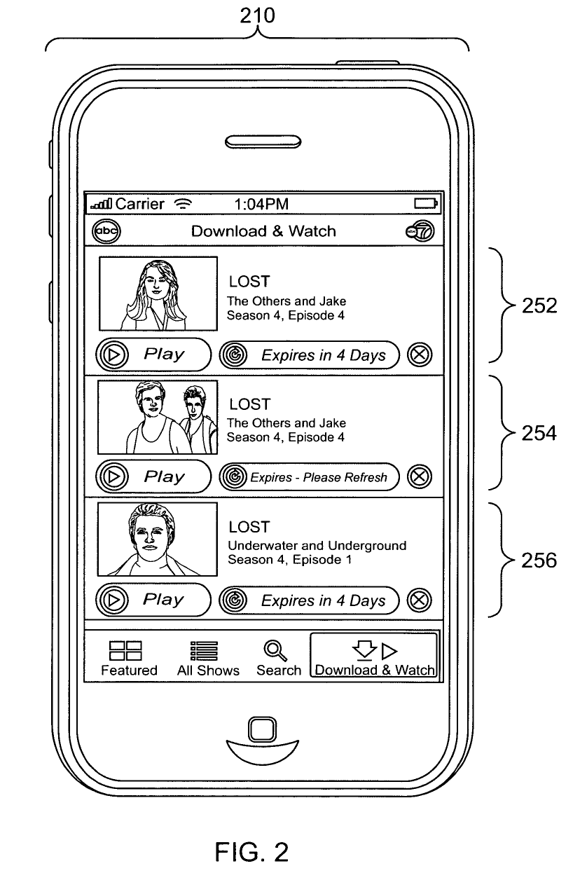

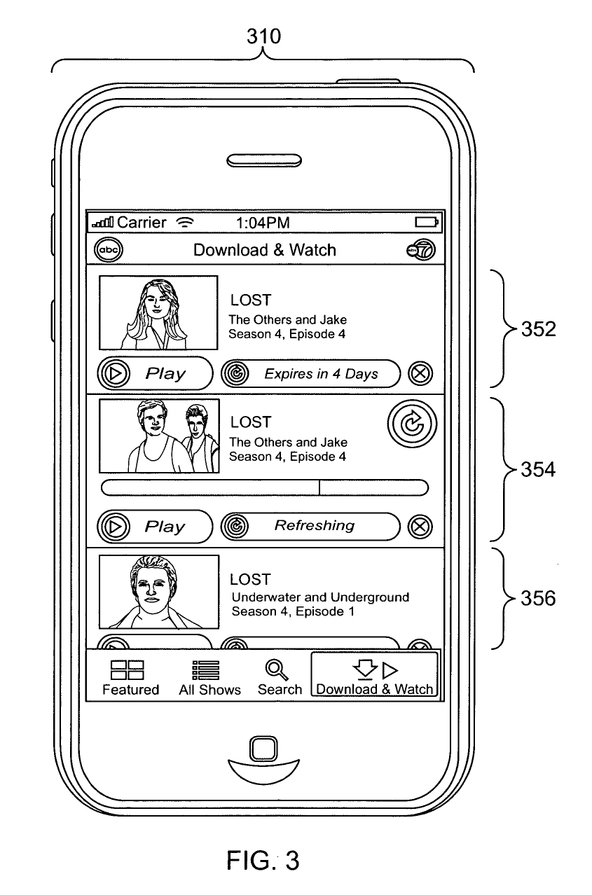

FIG. 2 shows exemplary user device 210 according to one embodiment of the present invention. User device 210 is implemented as, for example, an iPhone, and is configured to be coupled to a server corresponding to server 104 via a network corresponding to network 102. User device 210 comprises an advertisement package corresponding to advertisement package 112 and an entertainment package corresponding to entertainment package 114. The advertisement package of user device 210 is configured to store a plurality of advertisement data (e.g. advertisement 120b), and the entertainment package is configured to store a plurality of entertainment data (e.g. episode 122b). User device 210 further comprises, in one embodiment, a screen configured both for user input and for display. In particular, the screen can, for example, receive user input via a touch-sensitive layer or layers, and can, for example, display an advertisement or an episode via a display layer or layers. FIG. 3 shows exemplary user device 310 that corresponds to user device 210.

As shown in FIG. 2, user device 210 utilizes the screen to display, for example, a list of three episodes of the show Lost, e.g. episode 252, episode 254, and episode 256. A user of user device 210 may touch the screen to select either episode 252 or 256 for immediate display because, as indicated in FIG. 2 (and FIG. 3 with corresponding episodes 352 and 356) both episodes expire in 4 days. In particular, episodes 252 and 256, in one embodiment, have associated first entertainment expiration data implemented as time stamps that expire in 4 days. In another embodiment, episodes 252 and 256 may not expire in 4 days, but instead an advertisement (not shown in FIG. 2) has an associated first advertising expiration data that expires in 4 days. In such an embodiment, expiration of the advertisement will disable a display of all episodes. Notably, episode 254 is presently expired and may be refreshed by the user, via transactions corresponding to transactions 130, 132, and 134 in FIG. 1.

As shown in FIG. 3, a user of user device 310, after refreshing episode 254 in FIG. 2, in one embodiment is shown a progress bar on the screen of user device 310 while the transactions corresponding to transactions 130, 132, and 134 are performed. User device 310 may, for example, wirelessly couple to the server to transmit a first request that is configured as a request for both one or more of the plurality of entertainment data and one or more of the plurality of advertisement data on the server. The server responds by transmitting to user device 310 a new episode 354 as well as a new advertisement having first entertainment and advertising expiration data that are not yet expired. User device 310 may thereby display episode 354 without being affected by the expiration of the first advertising expiration data of the original advertisement that is set to expire in 4 days. Instead, the display of episode 354 (as well as episodes 352 and 356) will instead be limited by, for example, the later expiration of the first advertising expiration data of the new advertisement.

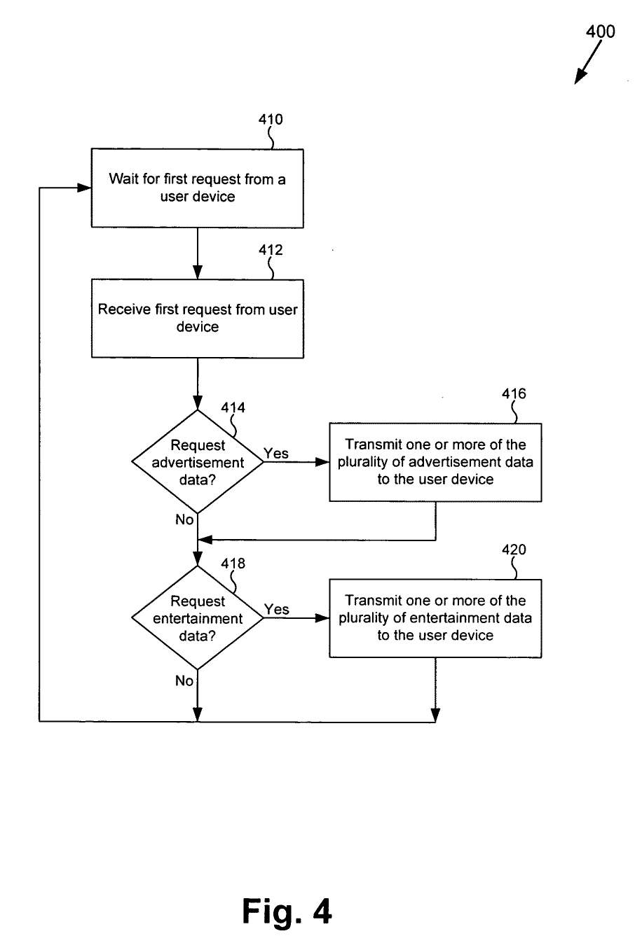

FIG. 4 shows flowchart 400 of an exemplary method for providing advertising and entertainment data, according to one embodiment of the present invention. Certain details and features have been left out of flowchart 400 that are apparent to a person of ordinary skill in the art. For example, a step may comprise one or more substeps or may involve specialized equipment or materials, as known in the art. While steps 410 through 420 indicated in flowchart 400 are sufficient to describe one embodiment of the present invention, other embodiments of the invention may utilize steps different from those shown in flowchart 400.

In step 410 of flowchart 400, a server corresponding to server 104 in FIG. 1 waits for a first request from a user device corresponding to user device 110. Like a first request as depicted in transaction 130, the first request can be configured, for example, as a request for one or more of the plurality of entertainment data stored in the server. The first request can also be configured, for example, as a request for one or more of the plurality of advertisement data stored in the server. In one embodiment, the first request can be configured as a request for both, i.e. one or more of the plurality of entertainment data and one or more of the plurality of advertisement data.

In step 412 of flowchart 400, the server receives the first request from the user device. The first request can be implemented, for example, as a digital message transmitted via a network corresponding to network 102 in FIG. 1. The first request may be transmitted by the user device under a variety of different circumstances. For example, in one circumstance, the user device transmits the first request after a first advertising expiration data of an advertisement corresponding to advertisement 124 has expired. In another circumstance, for example, the user device may transmit the first request after the first entertainment expiration data of an entertainment data corresponding to episode 126 has expired. In a variation of the latter circumstance, for example, the user device may transmit the first request after the first entertainment expiration data expires, and the first request is configured as a request for both one or more of the plurality of entertainment data and one or more of the plurality of advertisement data.

In step 414 of flowchart 400, the server determines whether the first request includes a request for advertisement data. If the first request does not, then flowchart 400 proceeds to step 418. If the first request does include such a request, flowchart 400 proceeds to step 416. In step 416 of flowchart 400, the server transmits one or more of the plurality of advertisement data to the user device. The server responds, in a transaction corresponding to transaction 132, by transmitting to the user device an advertisement, corresponding to advertisement 120b, having a first advertising expiration data that is not yet expired. Flowchart 400 then proceeds to step 418.

In step 418 of flowchart 400, the server determines whether the first request includes a request for entertainment data. If the first request does not, then flowchart 400 returns to step 410 to wait for a second request. If the first request does include such a request, flowchart 400 proceeds to step 420. In step 420 of flowchart 400, the server transmits one or more of the plurality of advertisement data to the user device. The server responds, in a transaction corresponding to transaction 134, by transmitting to the user device an episode, corresponding to episode 122b, having a first entertainment expiration data that is not yet expired. Flowchart 400 then returns to step 410 to wait for a second request.

In the manner described above, some embodiments of the present invention, which are shown in exemplary system 100, in FIGS. 2 and 3, as well as in exemplary flowchart 400 achieve improved provision of advertising and entertainment data while overcoming the drawbacks of conventional solutions. In one embodiment, advertisement data and entertainment data are stored on a server and provided to a user device as described above. The drawbacks of conventional solutions, which include difficulty coping with the requirements of advertising in both online and offline environments, are avoided.

From the above description of the invention it is manifest that various techniques can be used for implementing the concepts of the present invention without departing from its scope. Moreover, while the invention has been described with specific reference to certain embodiments, a person of ordinary skill in the art would recognize that changes can be made in form and detail without departing from the spirit and the scope of the invention. The described embodiments are to be considered in all respects as illustrative and not restrictive. It should also be understood that the invention is not limited to the particular embodiments described herein, but is capable of many rearrangements, modifications, and substitutions without departing from the scope of the invention.

What is claimed is:

1. A method of providing a plurality of advertisement data and a plurality of entertainment data, the method comprising:
receiving a first request from a user device for one or more of the plurality of entertainment data;
transmitting one or more of the plurality of advertisement data to the user device in response to the first request, wherein the one or more of the plurality of advertisement data include a first advertising expiration data associated with the one or more of the plurality of advertisement data for use to disable a display of the one or more of the plurality of advertisement data by the user device after an expiration of the first advertising expiration data; and
transmitting the one or more of the plurality of entertainment data to the user device in response to the first request, wherein the one or more of the plurality of entertainment data include a first entertainment expiration data for use to disable a display of the one or more of the plurality of entertainment data by the user device after an expiration of either the first entertainment expiration data or the first advertising expiration data.

2. The method of claim 1, further comprising:
receiving a second request from the user device for the one or more of the plurality of entertainment data;
transmitting the one or more of the plurality of advertisement data to the user device in response to the second request, wherein the one or more of the plurality of advertisement data include a second advertising expiration data associated with the one or more of the plurality of advertisement data for use to disable a display of the one or more of the plurality of advertisement data by the user device after an expiration of the second advertising expiration data; and
transmitting the one or more of the plurality of entertainment data to the user device in response to the second request, wherein the one or more of the plurality of entertainment data include a second entertainment expiration data for use to disable a display of the one or more of the plurality of entertainment data by the user device after an expiration of either the second entertainment expiration data or the second advertising expiration data.

3. The method of claim 1, further comprising receiving from the user device an advertising report.

4. The method of claim 1, wherein the first entertainment expiration data comprises an expiration date after which the one or more of the plurality of entertainment data expires.

5. The method of claim 1, wherein the first advertising expiration data comprises an expiration date after which the one or more of the plurality of advertisement data expires.

6. The method of claim 1, wherein the first advertising expiration data comprises an impression limit after which the one or more of the plurality of advertisement data expires.

7. The method of claim 1, wherein the receiving and the transmitting are performed via the Internet.

8. A system for providing a plurality of advertisement data and a plurality of entertainment data, the system comprising:
a memory storing the plurality of advertisement data and the plurality of entertainment data;
a processor, wherein the processor is configured to:
receive a first request from a user device for one or more of the plurality of entertainment data;
transmit one or more of the plurality of advertisement data to the user device in response to the first request, wherein the one or more of the plurality of advertisement data include a first advertising expiration data associated with the one or more of the plurality of advertisement data for use to disable a display of the one or more of the plurality of advertisement data by the user device after an expiration of the first advertising expiration data; and
transmit the one or more of the plurality of entertainment data to the user device in response to the first request, wherein the one or more of the plurality of entertainment data include a first entertainment expiration data for use to disable a display of the one or more of the plurality of entertainment data by the user device after an expiration of either the first entertainment expiration data or the first advertising expiration data.

9. The system of claim 8, wherein the processor is further configured to:
receive a second request from the user device for the one or more of the plurality of entertainment data;
transmit the one or more of the plurality of advertisement data to the user device in response to the second request, wherein the one or more of the plurality of advertisement data include a second advertising expiration data associated with the one or more of the plurality of advertisement data for use to disable a display of the one or more of the plurality of advertisement data by the user device after an expiration of the second advertising expiration data; and
transmit the one or more of the plurality of entertainment data to the user device in response to the second request, wherein the one or more of the plurality of entertainment data include a second entertainment expiration data for use to disable a display of the one or more of the plurality of entertainment data by the user device after an expiration of either the second entertainment expiration data or the second advertising expiration data.

10. The system of claim 8, wherein the processor is further configured to receive from the user device an advertising report.

11. The system of claim 8, wherein the first entertainment expiration data comprises an expiration date after which the one or more of the plurality of entertainment data expires.

12. The system of claim 8, wherein the first advertising expiration data comprises an expiration date after which the one or more of the plurality of advertisement data expires.

13. The system of claim 8, wherein the first advertising expiration data comprises an impression limit after which the one or more of the plurality of advertisement data expires.

14. The system of claim 8, wherein the system is coupled to the Internet.

15. A method of receiving one or more of a plurality of advertisement data and one or more of a plurality of entertainment data, the method comprising:
transmitting a first request to a server for the one or more of the plurality of entertainment data;
receiving the one or more of the plurality of advertisement data from the server in response to the first request, wherein the one or more of the plurality of advertisement data include a first advertising expiration data associated with the one or more of the plurality of advertisement data for use to disable a display of the one or more of the plurality of advertisement data after an expiration of the first advertising expiration data; and
receiving the one or more of the plurality of entertainment data from the server in response to the first request, wherein the one or more of the plurality of entertainment data include a first entertainment expiration data for use to disable a display of the one or more of the plurality of entertainment data after an expiration of either the first entertainment expiration data or the first advertising expiration data.

16. The method of claim 15, further comprising:
transmitting a second request to the server for the one or more of the plurality of entertainment data;
receiving the one or more of the plurality of advertisement data from the server in response to the second request, wherein the one or more of the plurality of advertisement data include a second advertising expiration data associated with the one or more of the plurality of advertisement data for use to disable a display of the one or more of the plurality of advertisement data after an expiration of the second advertising expiration data; and
receiving the one or more of the plurality of entertainment data from the server in response to the second request, wherein the one or more of the plurality of entertainment data include a second entertainment expiration data for use to disable a display of the one or more of the plurality of entertainment data after an expiration of either the second entertainment expiration data or the second advertising expiration data.

17. The method of claim 15, further comprising transmitting to the server an advertising report.

18. The method of claim 15, wherein the first entertainment expiration data comprises an expiration date after which the one or more of the plurality of entertainment data expires.

19. The method of claim 15, wherein the first advertising expiration data comprises an expiration date after which the one or more of the plurality of advertisement data expires.

20. The method of claim 15, wherein the first advertising expiration data comprises an impression limit after which the one or more of the plurality of advertisement data expires.
